(19) United States
(12) Patent Application Publication
(10) Pub. No.: US 2018/0314807 A1
(43) Pub. Date: Nov. 1, 2018

(54) FILE PERMISSION CONTROL METHOD

(71) Applicant: FUJIAN FOXIT SOFTWARE DEVELOPMENT JOINT STOCK CO., LTD., Fuzhou City (CN)

(72) Inventor: Jianping MEI, Fuzhou City (CN)

(21) Appl. No.: 15/772,119

(22) PCT Filed: Nov. 8, 2016
(86) PCT No.: PCT/CN2016/000616

§ 371 Date: Apr. 30, 2018

(30) Foreign Application Priority Data
Nov. 12, 2015 (CN) 201510770644.3

(51) Int. Cl. G06F 21/10; G06F 21/62; H04L 29/06; G06F 17/30

(52) U.S. Cl. CPC G06F 21/10; G06F 21/6209; H04L 63/102; G06F 2221/2141; H04L 2463/101; G06F 2221/2107; G06F 17/30011

(57) ABSTRACT

Disclosed in the present invention is a file permission control method. The method comprises: when a file is created, generate a unique identifier corresponding to the file, save the unique identifier into the file, encrypt the file, and save basic information of the file and author personal information into a DRM license server; when a user opens the file by means of a DRM client, acquire the basic information of the file and the corresponding author personal information from the DRM license server by means of the unique identifier, and send, by means of the author personal information, request information for acquiring permission information of the author, the request information comprising a user ID of the user in a user center server; the author queries for personal information of the user in the user center server according to the user ID, and if the personal information of the user is found, operates, by means of the DRM client, the ID and a permission granted to the user, and sends the ID and the permission to the DRM license server and the user; and after receiving the information indicating that the permission is granted, the user online acquires a permission template of the file from the DRM license server by means of the unique identifier, and opens the file according to an assigned permission.

### TECHNICAL FIELD

The present invention relates to a field of digital rights management (DRM), and in particular, to a field of a document right control method.

### BACKGROUND

FIG. 1 illustrates a diagram of an architecture of an existing DRM system. An owner or a manager of a document assigns that which users may possess what rights specifically corresponding to the document. When opening the document, a user obtains a content key and a right policy from a server, and decrypts the document and the right policy by using the content key so as to control the right to use the document, thereby achieving steps of producing an encapsulation in advance.

However, in fact, many document authors don't know whom the document is authorized to at first. When their works is protected by means of DRM and then published onto the website, many users want to read the works because of an introduction of the works, but the users are not authorized, which often causes the document authors to be in a dilemma.

### SUMMARY

The present invention provides a document right control method, which is used for realizing that the owner of the document does not need to assign a user and a right possessed by the user at first, and does not need to execute the steps of producing an encapsulation in advance, thereby achieving producing an encapsulation by means of real-time interaction.

To achieve the above purpose, the present invention provides a document right control method, comprising the following steps:

when a document is created, generating a unique identifier corresponding to the document, saving the unique identifier into the document, encrypting the document, and saving basic information of the document and corresponding author personal information of the document into a DRM license server, wherein the DRM license server stores according to a one-to-one correspondence principle between the unique identifier corresponding to the document and the basic information and the author personal information of the document;

when a user opens the document by means of a DRM client, obtaining the basic information of the document and the corresponding author personal information of the document from the DRM license server by means of the unique identifier, and sending to the author request information for obtaining license information of the author according to the author personal information, wherein, the request information comprises a user ID of the user in a user center server;

after the author receives the request information, querying for personal information of the user according to the user ID in the user center server, and if the personal information of the user is found, operating the ID and a right authorized to the user by means of the DRM client, and sending the ID and the right to the DRM license server and the user; and

after the user receives information indicating that the right has been authorized to the user, online obtaining a right template of the document from the DRM license server by means of the unique identifier, and opening the document according to the right template.

Further, the document right control method further comprises the following steps:

exporting the right template into an offline mode by the DRM client, and viewing the right template on a mobile device.

Further, the right control method further comprises the following steps before the step that a user opens the document by means of a DRM client:

permitting that the user queries for the basic information of the document saved in the DRM license server by means of the DRM client, and permitting that the user downloads a required document.

Further, the personal information includes a profile of the author, an account ID of the author, and at least one contact detail such as a cell phone number of the author, an account in a network communication client and an e-mail account.

Further, the document right control method further comprises the following steps:

the author operating by means of the DRM client, and revoking a user's right of reading the document of the author according to the ID of the user.

In the present invention, after the works of an author is published onto the website, when users want to read the works because of the introduction of the works, they obtain the personal information of the author from the DRM license server by means of the unique identifier to come into contact with the author, and the author may authorize corresponding rights to the applicants by means of the DRM license server, thereby achieving dynamic package of digital content by means of real-time interaction.

### BRIEF DESCRIPTION OF THE DRAWINGS

In order to clearly describe the embodiments of the present invention or the technical solutions of the prior art, the embodiments or the drawings for description of the prior art will be simply explained as follows. Obviously, the drawings in the following description are only some embodiments of the present invention. For those ordinary skilled in the art of the present invention, on the premise of not contributing creative labor, those ordinary skilled in the art can also obtain other drawings in accordance with these figures.

FIG. 1 illustrates a diagram of an architecture of an existing DRM system; and

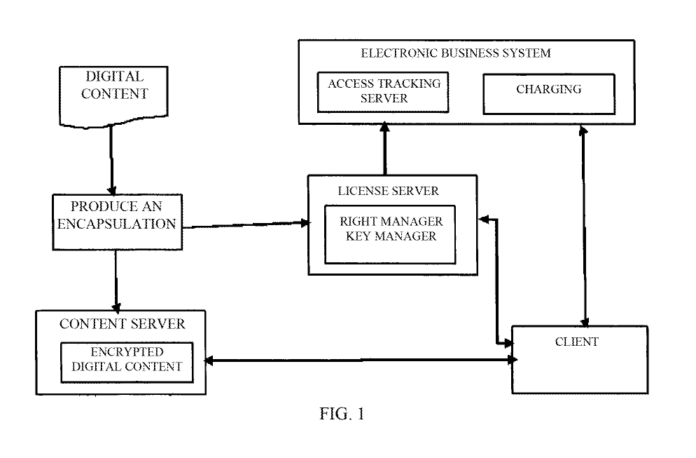

FIG. 2 is a flow chart of a document right control method of one embodiment of the present invention.

### DETAILED DESCRIPTION

The technical solutions of the embodiments of the present invention will be clearly and completely described in accordance with the drawings in the embodiments of the present invention. Obviously, the described embodiments are only partial embodiments of the present invention instead of all embodiments. On the basis of the embodiments of the present invention, all other embodiments obtained by those ordinary skilled in the art without contributing creative labor will belong to the protection scope of the present invention.

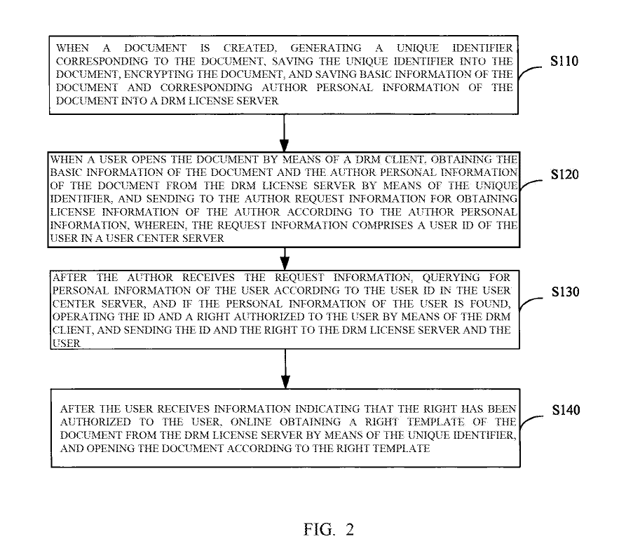

FIG. 2 is a flow chart of a document right control method of one embodiment of the present invention. As shown in the FIG. 2 the document right control method comprises the following steps:

S110. When a document is created, generating a unique identifier corresponding to the document, saving the unique identifier into the document, encrypting the document, and saving basic information of the document and corresponding author personal information of the document into a DRM license server, wherein the DRM license server stores according to a one-to-one correspondence principle between the unique identifier corresponding to the document and the basic information and the author personal information of the document;

S120. When a user opens the document by means of a DRM client, obtaining the basic information of the document and the corresponding author personal information of the document from the DRM license server by means of the unique identifier, and sending to the author request information for obtaining license information of the author according to the author personal information, wherein, the request information comprises a user ID of the user in a user center server;

S130. After the author receives the request information, querying for personal information of the user according to the user ID in the user center server, and if the personal information of the user is found, operating the ID and a right authorized to the user by means of the DRM client, and sending the ID and the right to the DRM license server and the user; and

S140. After the user receives information indicating that the right has been authorized to the user, online obtaining a right template of the document from the DRM license server by means of the unique identifier, and opening the document according to the right template.

To facilitate the user in viewing the document on the mobile device, the document right control method may further comprise the following steps:

exporting the right template into an offline mode by the DRM client, and viewing the right template on a mobile device.

The user may obtain the document in at least one creating a document way of: copying from other users, downloading from the website where the document is published, or downloading by means of the DRM client.

To facilitate the user in searching for the document by means of the DRM client, the right control method further comprises the following steps before the step that a user opens the document by means of a DRM client:

permitting that the user queries for the basic information of the document saved in the DRM license server by means of the DRM client, and permitting that the user downloads a required document.

Wherein, the author personal information includes a profile of the author, an account ID of the author, and at least one contact detail such as a cell phone number of the author, an account in a network communication client and an e-mail account. In this way, when readers open the document and find that they possess no right to read the document, they may obtain the personal information of the author from the DRM license server by means of the unique identifier of the document, and then obtain a corresponding right of the user from the author by means of a cell phone short message, a voice, an IM communication or the like.

In addition, to facilitate the author in controlling the document right, the document right control method may further comprise the following steps: the author operates by means of the DRM client, and revoking a user's right of reading the document of the author according to the ID of the user.

In the above embodiment, after the works of the author is published onto the website, when users want to read the works because of the introduction of the works, they obtain the personal information of the author from the DRM license server by means of the unique identifier so as to come into contact with the author, and the author may authorize corresponding rights to the applicants by means of the DRM license server, thereby achieving a dynamic encapsulation of digital content by means of real-time interaction.

Those ordinary skilled in the art should understand that the drawings is only a schematic diagram of one embodiment, and modules or processes in the drawings are not necessarily necessary for the implementation of the present invention.

Those ordinary skilled in the art should understand that the modules in the device of the embodiment may be distributed in the device of the embodiment according to the description of the embodiment and may be located in one or more devices different from that of the present embodiment as well by making corresponding changes. The modules of the above embodiment may be combined into one module and may be further split into a plurality of sub-modules as well.

Finally, it should be noted that the above embodiments are only used for describing the technical solution of the present invention rather than limiting the same. Although the present invention is described in detail by referring to the above embodiments, those ordinary skilled in the art should understand that: the technical solution recorded in each of the above embodiments can be still amended, or some technical features therein can be replaced equivalently. However, these amendments or replacements do not enable the essence of the corresponding technical solution to depart from the spirit and the scope of the technical solution of various embodiments of the present invention.

1. A document right control method, wherein the method comprises the following steps:
when a document is created, generating a unique identifier corresponding to the document, saving the unique identifier into the document, encrypting the document, and saving basic information of the document and corresponding author personal information of the document into a DRM license server, wherein the DRM license server stores according to a one-to-one correspondence principle between the unique identifier corresponding to the document and the basic information and the author personal information of the document;
when a user opens the document by means of a DRM client, obtaining the basic information of the document and the author personal information of the document from the DRM license server by means of the unique identifier, and sending to the author request information for obtaining license information of the author according to the author personal information, wherein, the request information comprises a user ID of the user in a user center server;
after the author receives the request information, querying for personal information of the user according to the user ID in the user center server, and if the personal information of the user is found, operating the ID and a right authorized to the user by means of the DRM client, and sending the ID and the right to the DRM license server and the user; and
after the user receives information indicating that the right has been authorized to the user, online obtaining a right template of the document from the DRM license server by means of the unique identifier, and opening the document according to the right template.

2. The document right control method according to claim 1, wherein the method further comprises the following steps:
exporting the right template into an offline mode by the DRM client, and viewing the right template on a mobile device.

3. The document right control method according to claim 1, wherein the method further comprises the following steps before a user opens the document by means of a DRM client:
permitting that the user queries for the basic information of the document saved in the DRM license server by means of the DRM client, and permitting that the user downloads a required document.

4. The document right control method according to claim 1, wherein, the personal information includes a profile of the author, an account ID of the author, and at least one contact detail such as a cell phone number of the author, an account in a network communication client and an e-mail account.

5. The document right control method according to claim 1, wherein the method further comprises the following steps:
the author operating by means of the DRM client, and revoking a user's right of reading the document of the author according to the ID of the user.
